(19) United States
(12) Patent Application Publication
(10) Pub. No.: US 2012/0047355 A1
(43) Pub. Date: Feb. 23, 2012

(54) Information Processing Apparatus Performing Various Bit Operation and Information Processing Method Thereof

(75) Inventors: Eiji Iwata, Kanagawa (JP); Ryohei Okada, Chiba (JP)

(73) Assignees: Sony Computer Entertainment Inc., Tokyo (JP); Sony Corporation, Tokyo (JP)

(21) Appl. No.: 13/189,809

(22) Filed: Jul. 25, 2011

(30) Foreign Application Priority Data
Jul. 30, 2010 (JP) 2010-172614

(51) Int. Cl. G06F 9/305

(52) U.S. Cl. 712/223; 712/E09.018

(57) ABSTRACT

An information processing apparatus operates data stored in an input register for each bit and stores a result thereof in an output register. A selector circuit selects output data of a bit from input data of 128 bits in the input register. An AND circuit outputs, only when data from a corresponding selector circuit is valid, the data to a corresponding bit of the output register. A control signal generator inputs a select signal indicating the number of a bit to be selected to each selector circuit, and also inputs a signal indicating whether data input from the selector circuit is valid or invalid to each AND circuit.

### BACKGROUND OF THE INVENTION

1. Field of the Invention

The present invention relates to information processing technology and specifically to an information processing apparatus and an information processing method for operating data in units of bits.

2. Description of the Related Art

In recent years, various variable-length coding methods are in practical use in compression techniques for audio data and video data. In general, an individual variable-length code obtained by a variable-length coding process is once stored in a storage area having a fixed bit length in memory or a register in a sequential manner. By performing a bit operation, such as bit shift, so that only the code is taken out from the storage area for each variable-length code, all variable-length codes are linked without a space so as to generate final compressed data (e.g., see Japanese Patent Laid Open Publication 2006-13867).

In addition to the link process of variable-length codes, a bit operation is also required for may information processes. A barrel shifter is used for a bit operation such as a shift/rotate process in a general microprocessor, mainly for the purpose of reducing the hardware cost. On the other hand, in current microprocessors or the like to which SIMD (Single Instruction Multiple Data) is applied, shift/rotate instructions are diversified, and instructions such as a permute instruction and a bit select instruction are further added. Thus, the processes thereof are becoming more complicated.

In the case of linking variable-length codes by using a barrel shifter or the like, it is necessary to perform a logical operation or a shift operation to the number of the variable-length codes since a bit operation is basically performed for a process in units of variable-length codes. As a result, the time required for the link process increases as the size of original data increases, having adverse effects on the final compressed-data generation time that cannot be overlooked. Further, even instructions that can be realized in microprocessors such as the ones above are vulnerable to, for example, an address calculation in the fast Fourier transform (FFT) algorithm or an operation in units of bits that is necessary for the DES (Data Encryption Standard) algorithm, being a cause for poor performance compared to a dedicated circuit.

### RELATED ART LIST

JPA laid open 2006-13867

### SUMMARY OF THE INVENTION

In this background, a purpose of the present invention is to provide an information processing technique that allows various bit operations to be performed in a versatile and efficient manner.

One embodiment of the present invention relates to an information processing apparatus. The information processing apparatus for operating data stored in an input register in units of bits so as to store the operated data in an output register, comprises: a pair of an input circuit and an output circuit provided corresponding to each bit in the output register; and a control signal generator configured to generate signals to be input to the input circuit and the output circuit, respectively, in accordance with the details of a bit operation, wherein the input circuit, using a plurality of values stored in a plurality of bits in the input register as input values, selects one value from among the input values and outputs the selected value to the corresponding output circuit in accordance with a bit selection signal from the control signal generator, and the output circuit acquires a signal, which indicates whether a corresponding bit in the output register is valid or invalid, from the control signal generator and outputs an output value from the corresponding input circuit to the corresponding bit in the output register when the bit is valid.

Another embodiment of the present invention relates to an information processing method. The information processing method for operating data stored in an input register in units of bits so as to store the operated data in an output register, comprises: acquiring a value stored in a single bit selected, in accordance with the details of an operation, from among bits in the input register; and determining whether or not the acquired value is valid based on the bit number of data to be stored in the output register and then storing the value in the output register when the value is valid, wherein the acquiring and the determining are performed in parallel for each bit in the output register.

Optional combinations of the aforementioned constituting elements, and implementations of the invention in the form of methods, apparatuses, systems, computer programs, and recording media recording computer programs may also be practiced as additional modes of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram illustrating the configuration of a data generation apparatus in an embodiment;

FIG. 2 is a diagram illustrating an example of a bit string before and after linking when a variable-length code is stored in every 8-bit unit region in the embodiment;

FIG. 3 is a diagram illustrating an example of a bit string before and after linking when a variable-length code is stored in every 16-bit unit region in the embodiment;

FIG. 4 is a diagram illustrating, in detail, the configuration of a control signal generator in the data generation apparatus used for linking variable-length codes in the embodiment;

FIG. 5 is a flowchart illustrating a processing sequence of a select signal generation unit generating a select signal in the embodiment;

FIG. 6 is a flowchart illustrating a processing sequence of an invalid-bit instruction unit generating a signal to be input to a corresponding AND circuit in the embodiment;

FIG. 7 is a diagram schematically illustrating a relationship of a bit string before and after bit reverse that can be achieved in the embodiment;

FIG. 8 is a diagram explaining a principle of generating a select signal to be input to each selector circuit of an information processing apparatus when bit reverse is performed in the embodiment;

FIG. 9 is a diagram illustrating, in detail, the configuration of the select signal generation unit that generates a select signal when a bit reverse process is performed in the embodiment;

FIG. 10 is a diagram schematically illustrating a relationship of a bit string before and after gathering that can be achieved in the embodiment;

FIG. 11 is a diagram explaining a principle of generating a select signal to be input to each selector circuit of the information processing apparatus when gathering is performed in the embodiment; and

FIG. 12 is a diagram illustrating, in detail, the configuration of the select signal generation unit that generates a select signal when a gathering process is performed in the embodiment.

### DETAILED DESCRIPTION OF THE INVENTION

The invention will now be described by reference to the preferred embodiments. This does not intend to limit the scope of the present invention, but to exemplify the invention.

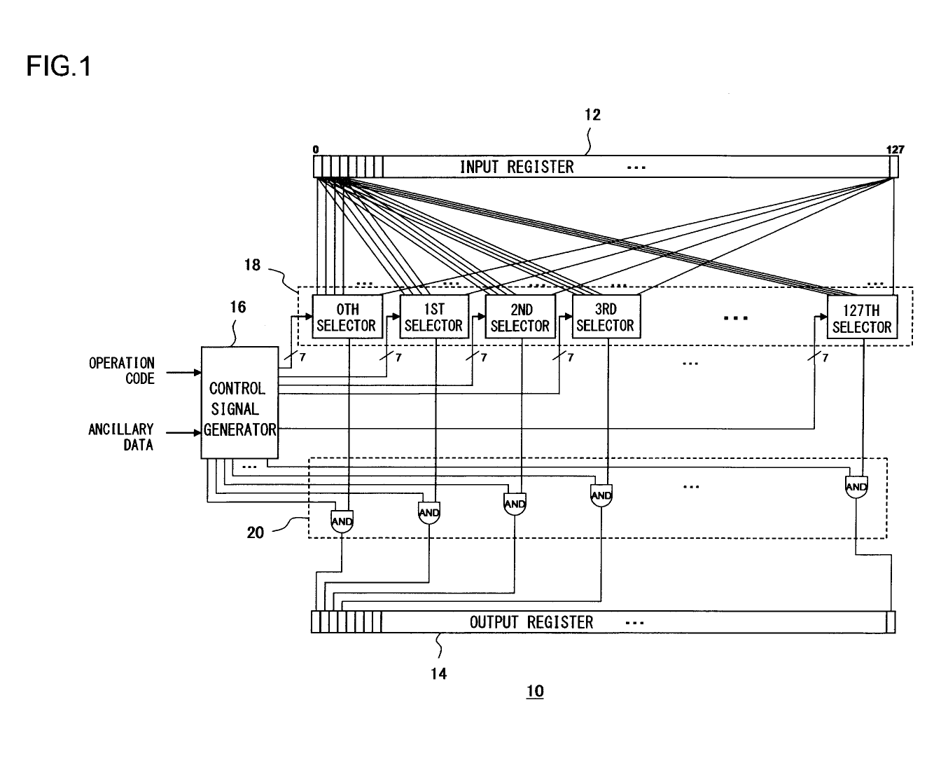

FIG. 1 illustrates the configuration of a data generation apparatus in the embodiment. An information processing apparatus 10 performs a bit operation on data stored in an input register 12 and stores a result thereof in an output register 14. Both the input register 12 and the output register 14 have a size of 128 bits, and a single section in a rectangle, which represents each register, represents one bit in the figure. The size of the registers is not limited to this and may be determined appropriately in consideration of the type of data to be processed, a required specification, limitations in the hardware configuration, etc.

The information processing apparatus 10 further includes: 128 pairs of selector circuits 18 and AND circuits 20 provided so as to correspond to the respective bits of the output register 14; and a control signal generator 16 that controls the selector circuits 18 and the AND circuits 20. In the figure, reference numerals are assigned so that 128 selector circuits are generically referred to as a selector circuit 18 and so that 128 AND circuits are generically referred to as an AND circuit 20. Hereinafter, an explanation may be given using ordinal numerals such that the 0th, 1st, 2nd, . . . , 127th selectors and the 0th, 1st, 2nd, . . . , 127th AND circuits correspond to the 0th, 1st, 2nd, . . . , 127th bits of the output register, respectively, from the left in the figure.

The selector circuit 18 has connection lines that connect to 128 bits of the input register 12, respectively, and uses data stored in the respective bits as an input value. The selector circuit 18 then selects one set of data according to a select signal from the control signal generator 16 and outputs the data to the corresponding AND circuit 20. The AND circuit 20 outputs, using the data from the corresponding selector circuit 18 and the value output by the control signal generator 16 as input values, a logical product of the data and the value to the corresponding bit of the output register 14.

An operation code indicating an instruction for a bit operation and ancillary data related to the data stored in the input register 12 that is necessary for the bit operation are input to the control signal generator 16. The ancillary data may not be input depending on the details of the bit operation. As described in the following, data stored in another register (not shown) may be used for the ancillary data. The control signal generator 16 then generates respective signals for the 128 selector circuits 18 and AND circuits 20 and outputs the generated signals. A signal output to each selector circuit 18 is a select signal that indicates the ordinary number of a bit from which data should be selected by the selector circuit among the data in the 128 bits. Therefore, the signal is 7-bit information indicating any one of zero through 127, as shown in the figure.

A signal output to each AND circuit 20 by the control signal generator 16 indicates whether or not data received by the AND circuit from the corresponding selector circuit 18 should be stored in the output register 14. More specifically, “1” is input to the AND circuit when the data should be stored. Otherwise, “0” is input to the AND circuit. An output value of the AND circuit 20 to which “0” is input is always “0”. With this, whether the data from the selector circuit 18 is valid or invalid is clarified, and the information is incorporated in the data to be stored eventually in the output register 14. With such a configuration, a data generation apparatus can be realized that is generally applicable to various processes that require a bit operation. An explanation is given in the following regarding a specific example thereof.

(1) Linking of Variable-Length Codes

In general, variable-length coding is performed on the digital data of an image or a sound in a compression process. A generated variable-length code is sequentially stored in a unit region having a fixed bit length of a power of two (e.g., 8 bits, 16 bits, 32 bits, etc.) in memory or a register. On the other hand, in the case of outputting final compressed data, it is necessary to exclude a bit, in a bit string forming a unit region, that does not store a variable-length code and then link all variable-length codes without a space. The information processing apparatus 10 is used in this process so as to link variable-length codes stored in the input register 12 before the linking and then store the linked variable-length codes in the output register 14.

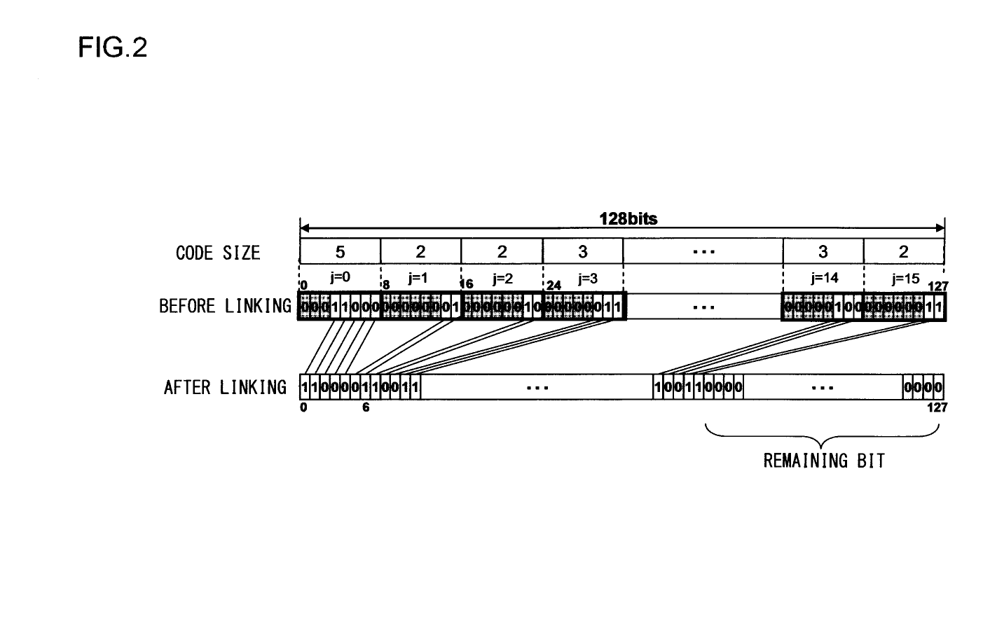

FIG. 2 illustrates an example of a bit string before and after the linking when a variable-length code is stored for every 8-bit unit region. In a register of 128 bits, a variable-length code of up to eight bits is stored in each of sixteen unit regions from the 0th through 15th unit regions that are shown by rectangles with thick lines, before the linking. Hereinafter, the number of a unit region is sometimes represented as “j”, where 0≦j≦15 for a unit region of eight bits. In the figure, it is assumed that a valid code is stored in a bit other than those that are shaded. For example, in the 0th unit region (j=0) composed of the 0th through the 7th bits, a code “11000” is stored in five bits from the 3rd to the 7th bits. In the 1st unit region (j=1) composed of the 8th through the 15th bits, a code “01” is stored in two bits from the 14th to the 15th bits.

In the figure, the size of a code stored in each unit region is shown above a bit string before the linking. For example, it can be found that the 0th unit region stores a variable-length code of “5” bits and that the 1st unit region stores a variable-length code of “2” bits. The data is generally acquired in the middle of a variable-length coding process. An invalid bit shown shaded is excluded from the data before the linking so as to generate data after the linking by storing valid data in a packed manner. As a result, data “1100001 . . . ” is generated as output data.

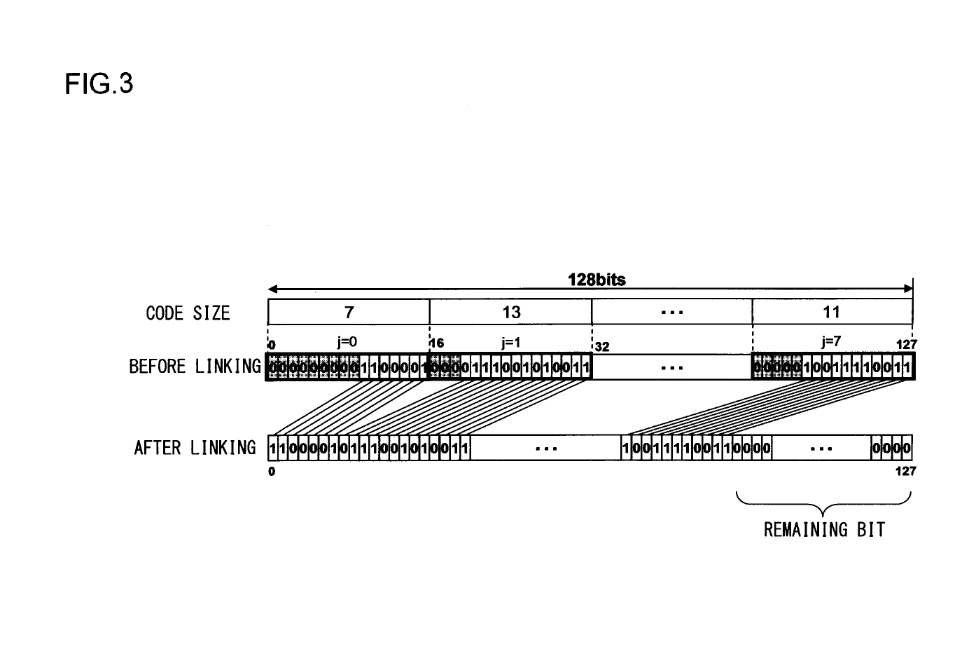

FIG. 3 is a similar example and illustrates an example of a bit string before and after the linking when a variable-length code is stored for every 16-bit unit region. In this case, a variable-length code of up to sixteen bits is stored in each of eight unit regions from 0th through 7th unit regions that are shown with thick lines, before the linking. For example, in the 0th unit region (j=0) composed of the 0th through the 15th bits, a code “1100001” is stored in seven bits from the 9th to the 15th bits. In the 1st unit region (j=1) composed of the 16th through the 31st bits, a code “0111001010011” is stored in thirteen bits from the 19th to the 31st bits. When these codes are linked in a similar manner as described above, data “11000010111001010011 . . . ” is generated as output data.

In performing such a process, it is a common practice, conventionally, to perform processes as follows for each unit region and repeat the processes to the number of the unit regions: (1) to perform bit shift so that a bit storing a valid code starts with the 0th bit; and (2) to store a code of a shifted bit string in a bit, starting with a bit that is subsequent to the last bit storing the valid code, in an output register. Therefore, it requires much more time that cannot be overlooked compared to a coding process.

In the present invention, data for the bits of the input register 12 before the linking is linked and stored in the output register 14 in a single step by using the information processing apparatus 10 shown in FIG. 1. In FIGS. 2 and 3, an example is shown where a variable-length code is stored in 8-bit or 16-bit unit region in a 128-bit input register. The same process can be applied even when these numbers of bits are changed.

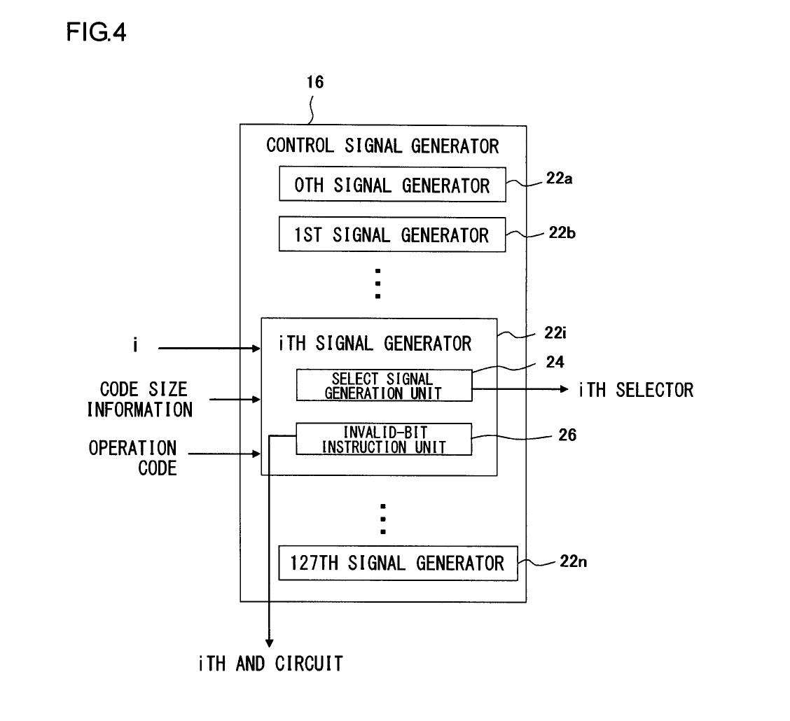

FIG. 4 shows the detailed configuration of the control signal generator 16 in the information processing apparatus 10 used for linking variable-length codes. In FIG. 4, the components described as functional blocks that perform various processes are provided by hardware such as microprocessors, registers, comparator circuits, adder circuits, and other circuits, or by software such as programs input as operation codes. Therefore, it will be obvious to those skilled in the art that the functional blocks may be implemented in a variety of manners by a combination of hardware and software.

The control signal generator 16 comprises 128 signal generators that are the 0th signal generator 22a, the 1st signal generator 22b, . . . , the 127th signal generator 22n. Since the respective configurations of these signal generators are the same, an explanation is given regarding an ith signal generator 22i (0≦i≦127) in the following. The ith signal generator 22i includes a select signal generation unit 24 and an invalid-bit instruction unit 26. The select signal generation unit 24 generates a select signal showing the number of a single bit to be selected among the 0th bit through the 127th bit of the input register 12. The select signal generated by the select signal generation unit 24 of the ith signal generator 22i is input to an ith selector circuit among 128 selector circuits 18 shown in FIG. 1.

The invalid-bit instruction unit 26 determines whether or not to output the output data from the selector circuit 18 to the output register 14, and outputs, to an ith AND circuit among 128 AND circuits shown in FIG. 1, “1” when the output data is to be output and “0” when the output data is not to be output. As shown in FIG. 2 and FIG. 3, a remaining bit that does not store a code is generated in the output register 14 as a result of linking variable-length codes, as long as all the variable-length codes have the same size as that of a unit region. By preventing output data from the selector circuit 18 from being output to the remaining bit, it is ensured that indeterminate data is not stored.

An operation code for performing a subsequently-described process and the value of “i” are input to the ith signal generator 22i in advance. An operation code is prepared for each size of a unit region in advance, and an operation code selected according to the actual unit region size is input. The value of “i” corresponds to a bit number, ranging from the 0th bit number through the 127th bit number, of the output register 14 connected via the selector circuit 18 or the AND circuit 20. Thus, the value is hereinafter referred to as an “output bit number.” Furthermore, as described above, code size information is input as ancillary data regarding a variable-length code stored in the input register 12. The code size information shows the number of bits of the variable-length code stored in each unit region and is exemplified as a “code size” in FIG. 2 and FIG. 3.

As shown in FIG. 2 and FIG. 3, in storing a variable-length code before the linking in the input register 12, the code size information may be stored in another register (not shown) so as to correspond to each unit region in advance and may be loaded appropriately by the ith signal generator 22i. A person skilled in the art should appreciate that the details of the variable-length coding process performed in a stage before a code is stored in the input register 12 are not limited in a particular manner and that there are many possible methods for acquiring code size information accordingly.

A detailed description will now be made regarding operations that can be realized by the configurations described thus far. FIG. 5 is a flowchart illustrating a processing sequence of a select signal generation unit 24 generating a select signal. In the figure, a variable “j” (j=0, 1, 2, . . . ) represents a unit region number in the input register 12 as described above. In the example shown in FIG. 2, j=0 for the 0th bit through the 7th bit, j=1 for the 8th bit through the 15th bit, j=2 for the 16th bit through the 23rd bit, . . . , among unit regions each corresponding to eight bits. The select signal generation unit 24 of the ith signal generator 22i first determines a unit region to which a bit belongs in the input register 12 that is to be selected by a corresponding ith selector circuit 18.

Therefore, the size (j) of a variable-length code stored in each unit region is added starting from the unit region for j=0 based on the code size information, and the value of j is obtained for when the sum thereof exceeds the output bit number i. More specifically, the addition starts from j=0, and the value of j is incremented so as to repeat the same determination process until the following expression is satisfied (S10, S12:N, and S14).

size (0)+size (1)+ . . . +size (j)>i The value of j when the above expression is satisfied is a unit region number of a unit region to which a bit to be selected belongs (S12:Y).

A variable “m” is now calculated that shows the ordinary number of the bit to be selected in the unit region of the number “j” that is obtained. More specifically, the following expression 1 is calculated (S16).

$$m = N - size ( j ) + ( i - {\sum }_{k = 0}^{j - 1} size ( k ) ) \qquad ( Expression 1 )$$

The notation N represents the number of bits in a unit region. Therefore, a variable n representing the ordinary number of the bit ranging from the 0th bit to the 127th bit in the input register 12 is calculated by using the obtained variable m as in the following Expression 2, and the value of variable n is the value of a select signal input into the ith selector circuit 18 (S18).

n=N*j+m (Expression 2)

For example, in the case of FIG. 2 (N=8), a bit to be selected before the linking by the 0th selector circuit, which outputs data to the 0th bit (i=0) in a bit string after the linking, is the 3rd bit (since m=8−5+0=3) in a unit region of the unit region number j=0 [since size (0)=5>0] and is the 3rd bit among all the bits (since n=8*0+3=3). A bit to be selected before the linking by the 6th selector circuit, which outputs data to the 6th bit (i=6) in the bit string after the linking, is the 7th bit [since m=8−2+(6−5)=7] in a unit region of the unit region number j=1 [since size (0)+size (1)=5+2>6] and is the 15th bit among all the bits (since n=8*1+7=15).

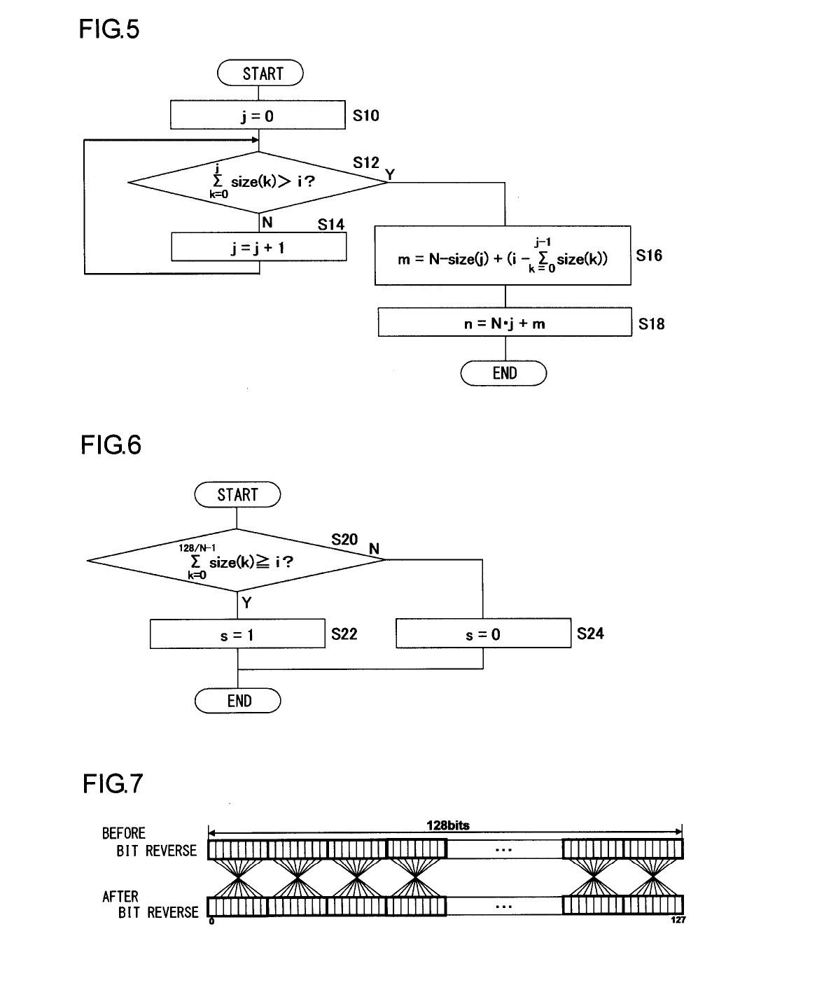

FIG. 6 is a flowchart illustrating a processing sequence of an invalid-bit instruction unit 26 generating a signal to be input to a corresponding AND circuit 20. The invalid-bit instruction unit 26 compares, with the output bit number i, the sum of the respective sizes (j) (j=0, 1, 2, . . . ) of variable-length codes in all the unit regions constituting the input register 12 (S20). The number of the unit regions is represented by 128/N. When the output bit number i is equal to or less than the sum of the sizes, an input signal s is indicated as “1” on the determination that output data from the ith selector circuit 18 is valid (S20:Y, S22). When the output bit number i is larger than the sum of the sizes, an input signal s is indicated as “0” on the determination that the output data from the ith selector circuit 18 is invalid (S20:N, S24).

The above process is similarly performed by the 0th signal generator 22a through the 127th signal generator 22n, inputting 128 select signals to the 0th selector circuit 18 through the 127th selector circuit 18, respectively, and 128 signals indicating whether the output data is valid or invalid to the 0th AND circuit 20 through the 127th AND circuit 20, respectively. With this, variable-length codes before the linking, which are stored in the input register 12, are selected by the respective selector circuit 18 and stored in corresponding bits in the output register 14, and “0” is stored in a remaining bit that does not store a variable-length code. This allows all the variable-length codes stored in the input register 12 to be linked all at once, dramatically reducing the time required for the process compared to the above-mentioned conventional method. Also, since an indeterminate variable is prevented from being assigned to a remaining bit produced as a result of the linking, a process in a subsequent stage can be easily performed, for example, in the case of further linking data.

(2) Bit Reverse

FIG. 7 schematically illustrates a relationship of a bit string before and after bit reverse performed by using the FFT algorithm, etc. The bit reverse is a process of reversing the bit order of data by storing data of the 0th bit in the last bit, data of the 1st bit in the second last bit, . . . , in each unit region comprising bits of a power of two (e.g., 8 bits, 16 bits, 32 bits, etc.). In the figure, unit regions are shown by rectangles with thick lines and have an 8-bit size. A correspondence relationship of bits storing the same data before and after the bit reverse is shown by a straight line connecting the bits.

An explanation is given, in the following, of a method of performing the bit reverse on the data for the size of the input register 12 and storing the bit-reversed data in the output register 14 in a single step by using the information processing apparatus 10 shown in FIG. 1. In this case, the control signal generator 16 may also have a configuration similar to that shown in FIG. 4.

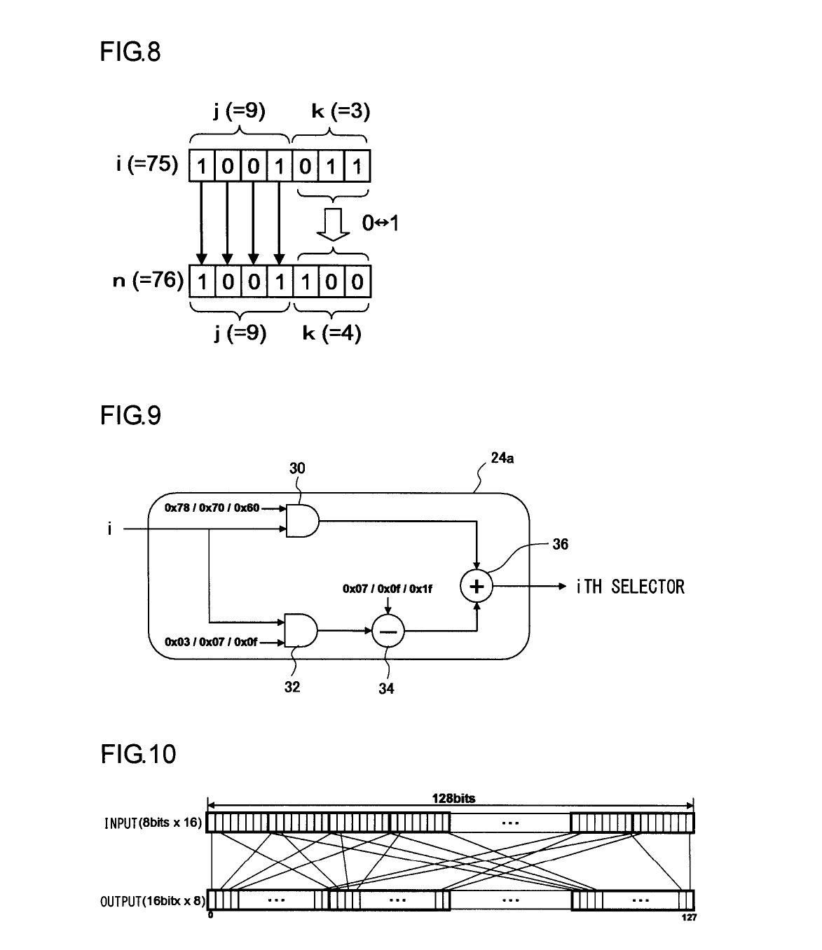

FIG. 8 is a diagram explaining a principle of generating a select signal to be input to each selector circuit 18 of the information processing apparatus 10 when bit reverse is performed. The variable i representing the number of the selector circuit 18 is 7-bit data since 0≦i≦127. The variable i corresponds to the number of a bit in the output register 14 after the bit reverse. As described above, since the number of bits present in a unit region is a power of two, the higher-order bits of the variable i corresponds to a unit region number j, and the lower-order bits correspond to a bit number applied in the unit region.

For example, when the unit region has eight bits, the four higher-order bits represent the unit region number j, and the three lower-order bits represent a bit number k applied in the unit region. An example (the one on the above) shown in FIG. 8 shows that a bit corresponding to the variable i=75(0b1001011) is a kth bit, k being represented by k=3(0b011), in the unit region with j=9(0b1001). The unit region number of each bit does not change before and after the bit reverse, and the bit number in the unit region is reversed. In other words, a value n representing the number of a bit before the bit reverse is obtained by maintaining the higher-order bits representing the unit region number in 7-bit data representing the bit number after the bit reverse, and by reversing the value of 0 or 1 of the remaining lower-order bits.

In an example (the one on the bottom) shown in FIG. 8, n=76(0b1001100) expressed by j=9(0b1001) and k=4(0b100) is obtained. In other words, in the bit reverse, the data to be stored in the 75th bit in the output register 14 is the data of the 76th bit in the input register 12. The same applies to other bits. Therefore, the value n is the value of a select signal to be input to the ith selector circuit 18. When the unit region has 16 bits or 32 bits, three higher-order bits and two higher-order bits represent the unit region number j, and the number of lower-order bits for which the value of 0 or 1 is reversed is thus changed accordingly.

FIG. 9 illustrates, in detail, the configuration of the select signal generation unit 24a that corresponds to the select signal generation unit 24 of the ith signal generator 22i shown in FIG. 4 and generates a select signal when a bit reverse process is performed. The select signal generation unit 24a includes two AND circuits 30 and 32, a subtraction circuit 34, and an adder circuit 36. In the figure, three hexadecimal numbers divided by slashes and shown as input values to the AND circuits 30 and 32 and the subtraction circuit 34 are values for the cases where the unit region has 8 bits/16 bits/32 bits, respectively. As described above, these values can be switched according to an operation code that is input. Such a configuration allows the above-stated value n of a select signal to be derived as shown in the following.

unit region with 8 bits: n=(i&0x78)+(0x07−(i&0x03))

unit region with 16 bits: n=(i&0x70)+(0x0f−(i&0x07))

unit region with 32 bits: n=(i&0x60)+(0x1f−(i&0x0f)) (Expression 3)

The notations “&,” “+,” and “−,” represent logical multiplication, arithmetic addition, and arithmetic subtraction, respectively.

In the Expression 3, the first term of the right hand side represents an operation of keeping the value of the higher-order bits, and the second term represents an operation of reversing the values of the lower-order bits. In the bit reverse, a remaining bit is not produced in the output register 14; therefore, the invalid-bit instruction unit 26 shown in FIG. 4 outputs “1” for all of the bits. The above process is similarly performed by the 0th signal generator 22a through the 127th signal generator 22n, inputting 128 select signals to the 0th selector circuit 18 through the 127th selector circuit 18, respectively, and 128 signals indicating that the output data is “valid” to the 0th AND circuit 20 through the 127th AND circuit 20, respectively. This configuration allows the bit reverse to be achieved easily in a small amount of time by using the information processing apparatus 10 shown in FIG. 1.

(3) Gathering

Gathering is a process of gathering data stored in bits that are apart from each other in a register so as to generate continuous data. FIG. 10 schematically illustrates a relationship of a bit string before and after the gathering. In the figure, the data of the 0th bit, the data of the 1st bit, . . . , the data of the 7th bit are gathered from 16 unit regions with 8 bits of the input data to form a unit region so that output data comprising eight unit regions with 16 bits is generated. If a unit region of the input data has 16 bits, the output data will comprise 16 unit regions with 8 bits, and if a unit region of the input data has 32 bits, the output data will comprise 32 unit regions with 4 bits.

An explanation is given, in the following, of a method of performing the gathering on the data for the size of the input register 12 and storing the gathered data in the output register 14 in a single step by using the information processing apparatus 10 shown in FIG. 1. In this case, the control signal generator 16 may also have a configuration similar to that shown in FIG. 4.

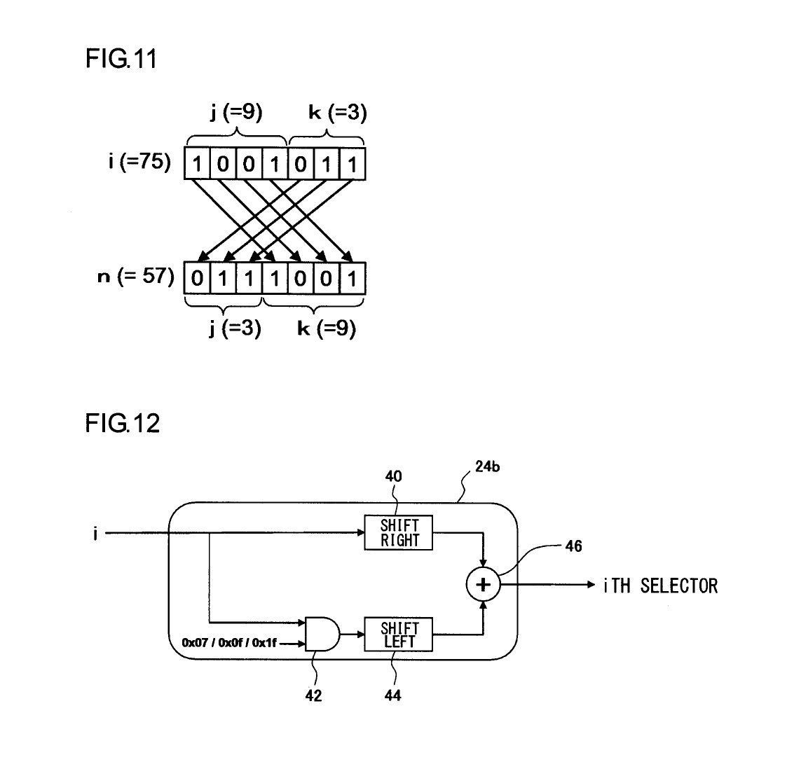

FIG. 11 is a diagram explaining a principle of generating a select signal to be input to each selector circuit 18 of the information processing apparatus 10 when the gathering is performed. As in the bit reverse, a variable i (0≦i≦127) represented by 7-bit is also operated in the gathering. More specifically, in the 7-bit data representing a bit number after the gathering, a bit number before the gathering is obtained by switching a unit region number j with a bit number k in the unit region.

In an example shown in FIG. 11, when j=9(0b1001) and k=3(0b011) in i=75(0b1001011) are switched with each other so as to obtain j=3(0b011) and k=9(0b1001), n=57(0b0111001) can be obtained. In other words, in the gathering, the data to be stored in the 75th bit in the output register 14 is the data of the 57th bit in the input register 12. The same applies to other bits. Therefore, the value n is the value of a select signal to be input to the ith selector circuit 18.

FIG. 12 illustrates, in detail, the configuration of the select signal generation unit 24b that corresponds to the select signal generation unit 24 of the ith signal generator 22i shown in FIG. 4, and generates a select signal when a gathering process is performed. The select signal generation unit 24b includes a shift circuit 40 that performs left shift, an AND circuit 42, a shift circuit 44 that performs right shift, and an adder circuit 46. In the figure, three hexadecimal numbers divided by slashes and shown as input values to the AND circuit 42 are values for the cases where the unit region of the input data has 8 bits/16 bits/32 bits, respectively. As described above, these values can be switched according to an operation code that is input. Such a configuration allows the above-stated value n of a select signal to be derived as shown in the following.

unit region with 8 bits: n=(i>>3)+((i&0x07)<<4)

unit region with 16 bits: n=(i>>4)+((i&0x0f)<<5)

unit region with 32 bits: n=(i>>5)+((i&0x1f)<<6) (Expression 4)

The notations “<<” and “>>” represent a shift left logical and a shift right logical, respectively.

In the Expression 4, the first term of the right hand side represents an operation of shifting the higher-order bits toward the lower-order bits, and the second term represents an operation of shifting the lower-order bits toward the higher-order bits. In the gathering, a remaining bit is not produced in the output register 14 just like in the bit reverse; therefore, the invalid-bit instruction unit 26 shown in FIG. 4 outputs “1” for all of the bits. The above process is similarly performed by the 0th signal generator 22a through the 127th signal generator 22n, inputting 128 select signals to the 0th selector circuit 18 through the 127th selector circuit 18, respectively, and 128 signals indicating that the output data is valid to the 0th AND circuit 20 through the 127th AND circuit 20, respectively. This configuration allows the gathering process to be achieved easily in a small amount of time by using the information processing apparatus 10 shown in FIG. 1.

According to the above-described embodiments, a pair of a selector circuit and an AND circuit that correspond to each bit in an output register can be provided. The selector circuit, using the values of all the bits in the input register as input values, selects one value from among the values and outputs the selected value. A bit to be selected by each selector circuit is appropriately calculated according to the bit operation to be performed and the size of a unit region of the input register. An AND circuit outputs to an output register only a valid value from among output values from a corresponding selector circuit and outputs “0” for the rest of the values. Such a configuration allows for the realization of a data generation apparatus that is generally applicable to various bit operations such as the linking of variable-length codes, the bit reverse, and the gathering, with just a simple configuration. Since all the processes for bits that constitute an input register can be performed all at once, the time required for the processes can be reduced. Further, since whether data to be output to an output register is valid or invalid can be adaptively determined and incorporated in the data, identification of an invalid bit becomes easier in a subsequent process, for example, when a bit operation is further performed on the output data, making the process to be performed easily.

The bit operations shown in the present embodiments are intended to be illustrative only, and it will be obvious to those skilled in the art that various bit operations can be easily achieved and that the similar advantages as the those described above can thus be obtained, by inputting an appropriate operation code and necessary ancillary data to the control signal generator 16 in the configuration of the information processing apparatus 10 shown in FIG. 1.

Described above is an explanation of the present invention based on the embodiments. The embodiment is intended to be illustrative only, and it will be obvious to those skilled in the art that various modifications to constituting elements and processes could be developed and that such modifications are also within the scope of the present invention.

What is claimed is:

1. An information processing apparatus that performs bit manipulation utilizing data stored in an input register so as to store the operated data in an output register, comprising:
an input circuit and an output circuit pair provided corresponding to each bit in the output register; and
a control signal generator configured to generate a signal to be input to the input circuit and a signal to be output to the output circuit, respectively, in accordance with the details of a bit operation, wherein
the input circuit, using as input values a plurality of values stored in a plurality of bits in the input register, selects one value from among the input values and outputs the selected value to the corresponding output circuit in accordance with a bit selection signal from the control signal generator, and
the output circuit acquires a signal, which indicates whether a corresponding bit in the output register is valid or invalid, from the control signal generator and outputs an output value from the corresponding input circuit to the corresponding bit in the output register when the bit is valid.

2. The information processing apparatus according to claim 1, wherein
the input register stores a variable-length code in each unit region having a fixed length,
the input circuit selects a value to be stored in the corresponding bit in the output register so as to eliminate a bit, in the input register, that does not store a variable-length code so that a variable-length code is continuous, and
the output circuit that corresponds to a bit, in the output register, other than a bit in which a linked variable-length code is to be stored, determines the corresponding bit to be invalid and stores a predetermined fixed value on the corresponding bit.

3. The information processing apparatus according to claim 1, wherein the control signal generator inputs, to the output circuit, “1” when the corresponding bit in the output register is valid and “0” when the corresponding bit is invalid, as a signal that indicates whether the bit is valid or invalid, and wherein the output circuit outputs a logical product of the signal and the output value from the input circuit to the corresponding bit in the output register.

4. The information processing apparatus according to claim 1, wherein the input circuit selects a value to be stored in the corresponding bit in the output register so that the bitorder is reversed for each unit region having a fixed length of the input register.

5. The information processing apparatus according to claim 1, wherein the input circuit selects a value to be stored in the corresponding bit in the output register so that a plurality of bits having a predetermined bitspace in between in the input register become continuous.

6. The information processing apparatus according to claim 2, wherein the control signal generator inputs, to the output circuit, “1” when the corresponding bit in the output register is valid and “0” when the corresponding bit is invalid, as a signal that indicates whether the bit is valid or invalid, and wherein the output circuit outputs a logical product of the signal and the output value from the input circuit to the corresponding bit in the output register.

7. The information processing apparatus according to claim 2, wherein the control signal generator generates a bit selection signal to be input to each input circuit by acquiring code size information showing the size of a variable-length code stored in each unit region of the input register, adding the size starting from the first unit region of the input register, and calculating the bit shift from the position in the input register when the variable-length code is continuously stored in a bit starting with the first bit in the output register.

8. The information processing apparatus according to claim 4, wherein the control signal generator generates a bit selection signal for selecting a bit of a number that is represented by a bit string obtained by reversing the values of lower-order bits, the number of the lower-order bits corresponding to the size of the unit region, in a bit string in the output register, where the bit number of each bit is expressed in binary and outputs the bit selection signal to an input circuit that corresponds to each bit in the output register.

9. The information processing apparatus according to claim 5, wherein the control signal generator generates a bit selection signal for selecting a bit of a number represented by a bit string obtained by switching a higher-order bit and a lower-order bit with each other that can be divided in accordance with the predetermined space in a bit string in the output register, where the bit number of each bit is expressed in binary and outputs the bit selection signal to an input circuit that corresponds to each bit in the output register.

10. An information processing method for bit manipulation utilizing data stored in an input register so as to store the operated data in an output register, comprising:
acquiring a value stored in a single bit selected, in accordance with the details of an operation, from among bits in the input register; and
determining whether or not the acquired value is valid based on the ordinal number of data to be stored in the output register and then storing the value in the output register when the value is valid, wherein
the acquiring and the determining are performed in parallel for each bit in the output register.
